(19) United States
(12) Patent Application Publication
(10) Pub. No.: US 2010/0287331 A1
(43) Pub. Date: Nov. 11, 2010

(54) ELECTRONIC DEVICE AND METHOD FOR RECORDING POWER-ON TIME THEREOF

(75) Inventor: SHAO-MING KUO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/701,708

(22) Filed: Feb. 8, 2010

(30) Foreign Application Priority Data
May 8, 2009 (CN) 200910302185.0

(51) Int. Cl. G06F 12/00; G06F 12/02

(52) U.S. Cl. 711/103; 711/104; 711/E12.001; 711/E12.008

(57) ABSTRACT

An electronic device and a method for recording power-on time include a flash memory to store a plurality of bits used to record power-on time. The electronic device sets the plurality of bits stored in the flash memory to a first value, sets a changing interval, and copies the plurality of bits from the flash memory to a random access memory (RAM). The electronic device further searches for a first bit of the first value from the plurality of bits in the RAM, and records an index of the first bit of the first value in a variable. The electronic device further changes the bit corresponding to the variable to a second value and increases the variable by 1 when the changing interval arrives. The electronic device further writes the bit changed to the second value from the RAM to the flash memory.

### BACKGROUND

1. Technical Field

Embodiments of the present disclosure relate to electronic devices, and more particularly to an electronic device and a method for recording power-on time thereof.

2. Description of Related Art

Several electronic devices may work abnormally because of hardware or software problems after the electronic devices are sold. Thus, sellers of the electronic devices often give a period of time to assure quality of the electronic devices.

During this period of time, customers may return broken electronic devices to the sellers because the broken electronic devices work abnormally. In such a case, the sellers need to know power-on time of the electronic devices so as to analyze problems of the broken electronic devices.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of functional modules of one embodiment of an electronic device in accordance with the present disclosure;

FIG. 2 is a schematic diagram showing the electronic device of FIG. 1 recording power-on time in accordance with one embodiment of the present disclosure; and

FIG. 3 is a flowchart of one embodiment of a method for recording power-on time in accordance with the present disclosure.

### DETAILED DESCRIPTION

In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage device.

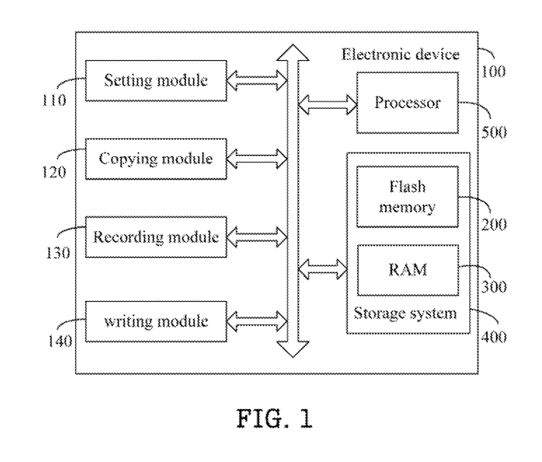

FIG. 1 is a schematic diagram of functional modules of one embodiment of an electronic device 100 in accordance with the present disclosure. In one embodiment, the electronic device 100 records power-on time thereof, namely recording how long the electronic device 100 is powered on (e.g., 1 hour). The electronic device 100 can be a mobile phone, a personal computer, a notebook computer, or a personal digital assistant (PDA), for example.

The electronic device 100 includes a setting module 110, a copying module 120, a recording module 130, a writing module 140, a storage system 400, and at least one processor 500. The storage system 400 includes a flash memory 200 and a random access memory (RAM) 300. The modules 110, 120, 130, 140 may comprise one or more computerized instructions which may be in the storage system 400 and executed by the at least one processor 500. Further description of the modules 110, 120, 130, 140 in conjunction with the electronic device 100 follows hereinafter.

The RAM 300 is operable to temporarily store dynamic data to enhance performance of the electronic device 100. The flash memory 200 is operable to store a plurality of bits used to record power-on time of the electronic device 100. The plurality of bits corresponds to a plurality of indexes. In one embodiment, the flash memory 200 reserves a fixed storage block, such as 64 KB, for storing the plurality of bits used to record the power-on time of the electronic device 100.

The setting module 110 is operable to set the plurality of bits which is used to record the power-on time stored in the flash memory 200, to a first value. The setting module 110 is further operable to set a changing interval, where the changing interval is used to change the bits with the first value to a second value one by one. In one embodiment, the bits with the second value indicate power-on time that has been recorded by the flash memory 200, and the bits with the first value indicate remaining power-on time that can be recorded by the flash memory 200. In one example, the first value is 1, and the second value is 0.

The copying module 120 is operable to copy the plurality of bits used to record the power-on time from the flash memory 200 to the RAM 300 when the electronic device 100 is powered on.

The recording module 130 is operable to search for a first bit of the first value from the plurality of bits in the RAM 300, and record the index of the first bit of the first value in a variable. The recording module 130 is further operable to change the bit corresponding to the variable to the second value, and increase the variable by 1 when the changing interval arrives. The bit changed to the second value is operable to indicate updated power-on time.

The writing module 140 is operable to determine whether all of the bits with the first value have been changed to the second value, and write the bit changed by the recording module 130 from the RAM 300 to the flash memory 200 when not all of the bits with first value have been changed to the second value.

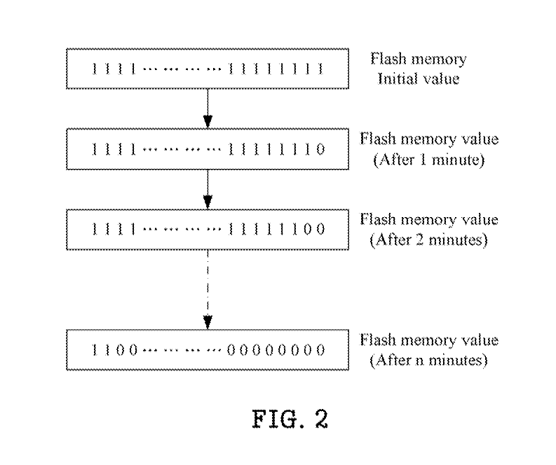

FIG. 2 is a schematic diagram showing the electronic device 100 of FIG. 1 recording power-on time in accordance with one embodiment of the present disclosure. In this embodiment, the setting module 110 sets each of the plurality of bits used to record power-on time in the flash memory 200 to 1 (the first value), when the electronic device 100 is powered on.

The copying module 120 copies the plurality of bits used to record power-on time from the flash memory 200 to the RAM 300 when the electronic device 100 is powered on. The setting module 110 sets a changing interval, such as 1 minute. The recording module 130 searches for a first bit of 1 (the first value) from the plurality of bits in the RAM 300, and records an index of the searched bit in variable n. Here, the plurality of bits in the RAM 300 are all 1 (the first value), so the index of the searched bit is 1. That is, variable n is equal to 1.

When 1 minute of the changing interval arrives, that is, the electronic device 100 has been powered on for 1 minute, the recording module 130 changes the bit corresponding to variable n (n=1) to 0 (the second value), and increases variable n by 1. In other words, the recording module 130 changes the first bit of 1 (the first value) in the RAM 300 to 0 (the second value), and adds variable n (n=1) by 1 to get new variable n (n=2). The changed bit is operable to indicate updated power-on time.

Subsequently, the writing module 140 determines whether all the bits with the first value have been changed to the second value, and writes the bit changed to the second value from the RAM 300 to the flash memory 200 when not all the bits with the first value have been changed to the second value. Referring to FIG. 2, here the first bit in the flash memory 200 is 0 (the second value), and the other bits are all 1 (the first value).

When 1 minute of the changing interval arrives again, that is, the electronic device 100 has been powered on for 2 minutes, the recording module 130 changes the bit corresponding to the variable n (n=2) to 0 (the second value), and increases variable n by 1. In other words, the recording module 130 changes the second bit of 1 (the first value) in the RAM 300 to 0 (the second value), and adds variable n (n=2 ) by 1 to get new variable n (n=3). The current changed bit is also operable to indicate updated power-on time.

Subsequently, the writing module 140 determines whether all the bits with the first value have been changed to the second value, and writes the current changed bit from the RAM 300 to the flash memory 200 when not all of the bits with the first value have been changed to the second value. Referring to FIG. 2, here the first and second bits in the flash memory 200 are both 0 (the second value), and the other bits are all 1 (the first value).

By analogy, the bits from the first to the nₜₕ in the flash memory 200 are all 0 (the second value), and the other bits are all 1 (the first value), after the electronic device 100 has been powered on for n minutes.

Therefore, the plurality of bits in the flash memory 200 reliably records the power-on time of the electronic device 100.

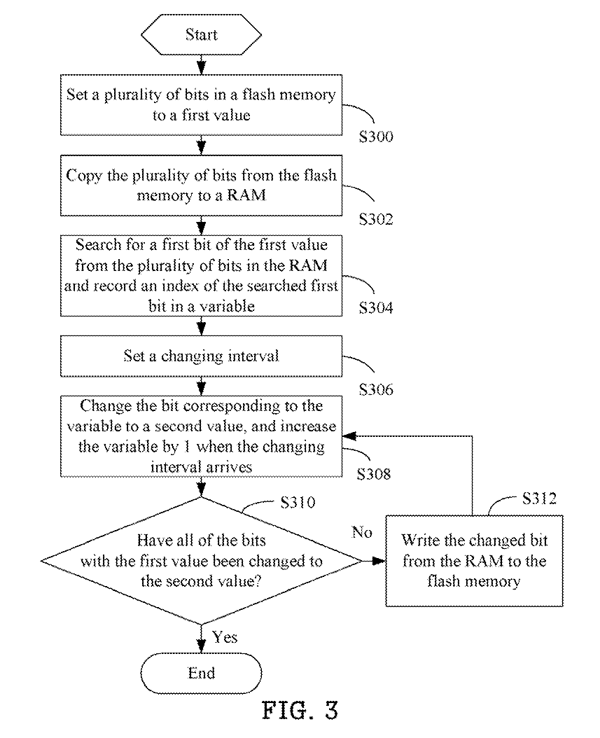

FIG. 3 is a flowchart of one embodiment of a method for recording power-on time in accordance with the present disclosure. The method is executed by the functional modules of FIG. 1. Depending on the embodiment, additional blocks may be added, others deleted, and the ordering of blocks may be changed while remaining well within the scope of the disclosure.

In block S300, the setting module 110 sets a plurality of bits stored in the flash memory 200 to a first value. In one embodiment, the plurality of bits in the flash memory 200 is used to record power-on time of the electronic device 100.

In block S302, the copying module 120 copies the plurality of bits from the flash memory 200 to the RAM 300 when the electronic device 100 is powered on.

In block S304, the recording module 130 searches for a first bit of the first value from the plurality of bits in the RAM 300, and records an index of the first bit of the first value in variable n.

In block S306, the setting module 110 sets a changing interval to change the bits with the first value to a second value one by one. In one embodiment, the first value is 1, and the second value is 0.

In step S308, the recording module 130 changes the bit corresponding to variable n to a second value, and increases variable n by 1 when the changing interval arrives. In one embodiment, the changed bit is operable to indicate updated power-on time.

In block S310, the writing module 140 determines whether all of the bits with the first value have been changed to the second value.

If not all of the bits with the first value have been changed to the second value, in block S312, the writing module 140 writes the changed bit from the RAM 300 to the flash memory 200.

The blocks S308-312 are loop-executed during the electronic device 100 powered on, until all of the bits with the first value have been changed to the second value or the electronic device 100 is powered off.

In the present disclosure, the writing module 140 only writes the changed bit indicating updated power-on time from the RAM 300 to the flash memory 200. That is, the flash memory 200 only has writing actions, but does not have erasing actions. Therefore, the flash memory 200 can reliably record the power-on time. Additionally, the copying module 120 and the writing module 140 perform copy/write functions on the flash memory 200 by bits to ensure efficient storage space usage by the flash memory 200.

While various embodiments of the present disclosure have been described above, it should be understood that they have been presented using example only and not using limitation. Thus the breadth and scope of the present disclosure should not be limited by the above-described embodiments, but should be defined only in accordance with the following claims and their equivalents.

What is claimed is:

1. An electronic device, comprising:
one or more processors;
a storage system, comprising:
flash memory operable to store a plurality of bits used to record power-on time of the electronic device, the plurality of bits corresponding to a plurality of indexes to positions of the bits;
and random access memory (RAM);
and one or more programs, wherein the one or more programs are stored in the storage system and configured to be executed by the one or more processors, the one or more programs including:
a setting module operable to set each of the plurality of bits stored in the flash memory to a first value, and operable to set a changing interval to change the bits with the first value to a second value one by one, wherein the bits with the second value indicate power-on time that has been recorded by the flash memory, and the bits with the first value indicate remaining power-on time that can be recorded by the flash memory;
a copying module operable to copy the plurality of bits from the flash memory to the RAM when the electronic device is powered on;
a recording module operable to search a first bit of the first value from the plurality of bits in the RAM, and record an index of the first bit of the first value in a variable, and operable to change the bit corresponding to the variable to the second value, and increase the variable by 1 when the changing interval arrives; and
a writing module operable to determine whether all of the bits with the first value have been changed to the second value, and write the bit changed by the recording module from the RAM to the flash memory when not all of the bits with the first value have been changed to the second value.

2. The electronic device as claimed in claim 1, wherein the first value and the second value are 1 and 0, respectively.

3. The electronic device as claimed in claim 1, wherein the flash memory reserves a fixed storage block operable to store the plurality of bits used to record the power-on time of the electronic device.

4. A method for recording power-on time, comprising:
providing flash memory and random access memory (RAM), wherein the flash memory is operable to store a plurality of bits used to record power-on time of an electronic device, and the plurality of bits corresponds to a plurality of indexes to positions of the bits;
setting the plurality of bits stored in the flash memory to a first value;
copying the plurality of bits from the flash memory to the RAM when the electronic device is powered on;
setting a changing interval to change the bits with the first value to a second value one by one, wherein the bits with the second value indicate power-on time that has been recorded by the flash memory, and the bits with the first value indicate remaining power-on time that can be recorded by the flash memory;
searching for a first bit of the first value from the plurality of bits in the RAM and recording an index of the first bit of the first value in a variable;
changing the bit corresponding to the variable to the second value and increasing the variable by 1 when the changing interval arrives;
determining whether all the bits with the first value have been changed to the second value using a processor; and
wherein if not all the bits with the first value have been changed to the second value, the processor writes the bit changed to the second value from the RAM to the flash memory.

5. The method as claimed in claim 4, wherein the first value and the second value are 1 and 0, respectively.

6. The method as claimed in claim 4, wherein the flash memory reserves a fixed storage block operable to store the plurality of bits used to record the power-on time of the electronic device.
